(19) United States
(12) Patent Application Publication
(10) Pub. No.: US 2025/0285780 A1
(43) Pub. Date: Sep. 11, 2025

(54) ATOMIC OBJECT CONFINEMENT APPARATUS HAVING PATTERNED COMPONENTS FORMED ON SURFACE ELECTRODES

(71) Applicant: Quantinuum LLC, Broomfield, CO (US)

(72) Inventors: Daniel Gerald OUELLETTE, Minneapolis, MN (US); Susan Eileen SHORE, Golden Valley, MN (US); Matthew BLAIN, Broomfield, CO (US); Adam Jay OLLANIK, Boulder, CO (US); Rezlind BUSHATI, Rockville, MD (US); Todd Michael KLEIN, Wayzata, MN (US); Christopher T. ERTSGAARD, Champlin, MN (US)

(21) Appl. No.: 19/051,849

(22) Filed: Feb. 12, 2025

Related U.S. Application Data
(60) Provisional application No. 63/562,327, filed on Mar. 7, 2024.

(51) Int. Cl. G21K 1/00; G02B 6/136; G21K 1/087

(52) U.S. Cl. CPC G21K 1/003; G02B 6/136; G21K 1/087

(57) ABSTRACT

An atomic object confinement apparatus includes a substrate comprising a plurality of vias; a plurality of segmented electrodes disposed on a surface of the substrate and in electric communication with respective vias of the plurality of vias; and a patterned component (e.g., metasurface, diffractive optical element, alignment marks) formed on an electrode surface of a segmented electrode of the plurality of segmented electrodes.

### CROSS-REFERENCE TO RELATED APPLICATION(S)

This application claims priority to U.S. Application No. 63/562,327, filed Mar. 7, 2024, the content of which is incorporated herein by reference in its entirety.

### TECHNICAL FIELD

Various embodiments relate to atomic object confinement apparatuses and methods for fabricating metasurfaces or other patterned components on surface electrodes of the atomic object confinement apparatuses. For example, various embodiments relate to the use of damascene processes for fabricating metasurfaces or other patterned components on surface electrodes of an atomic object confinement apparatus.

### BACKGROUND

Atomic object confinement apparatuses are used to confine or trap atomic objects, such as atoms, ions, molecules, and/or the like. For atomic object confinement apparatuses having integrated photonic elements, positioning the optical components with respect to the electrical components (e.g., surface electrodes, etc.) can be difficult. For example, a significant amount of the surface of the atomic object confinement apparatus may be filled with the segmented electrodes used to generate the trapping potential. Additionally, any electrical charge that becomes trapped on the optical components formed on the surface of the atomic object confinement apparatus could negatively affect operation of the atomic object confinement apparatus. Through applied effort, ingenuity, and innovation many deficiencies of such atomic object confinement apparatuses and methods of fabrication thereof have been solved by developing solutions that are structured in accordance with the embodiments of the present invention, many examples of which are described in detail herein.

### BRIEF SUMMARY OF EXAMPLE EMBODIMENTS

Example embodiments provide atomic object confinement apparatuses, system comprising atomic object confinement apparatuses, and methods for fabricating atomic object confinement apparatuses where the atomic object confinement apparatuses include at least one patterned component, such as a metasurface, for example, formed on segmented electrode of the atomic object confinement apparatus. In various embodiments, an atomic object confinement apparatus comprises a plurality of segmented surface electrodes. Application of voltage signals to the surface electrodes generates an electric potential near the surface of the atomic object confinement apparatus that is configured to confine and/or trap one or more atomic objects. In various embodiments, the surface electrodes are fabricated using a damascene process and have planarized electrode surfaces.

In various embodiments, patterned components such as optical metasurfaces are formed on one or more of the planarized electrode surfaces of the segmented surface electrodes. In various embodiments, the metasurfaces are configured to aid in providing optical beams and/or signals to respective locations defined at least in part by the atomic object confinement apparatus for interaction with atomic objects disposed and/or confined at the respective locations. In an example embodiment, the metasurfaces are configured to aid in collecting optical signals generated by atomic objects disposed and/or confined at respective locations defined at least in part by the atomic object confinement apparatus.

In an example embodiment, an atomic object confinement apparatus includes a substrate comprising a plurality of vias; a plurality of segmented electrodes disposed on a surface of the substrate and in electric communication with respective vias of the plurality of vias; and a patterned component formed on an electrode surface of a segmented electrode of the plurality of segmented electrodes.

In an example embodiment, a system including an atomic object confinement apparatus is provided. For example, the system may be a quantum charge-coupled device (QCCD)-based quantum computer that includes an atomic object confinement apparatus according to an example embodiment that is configured to confine a plurality of atomic objects that are used as qubits of the quantum computer.

In an example embodiment, a method for fabricating an atomic object confinement apparatus is provided. The method includes forming, on a surface of a substrate including a plurality of metal routing features (configured for routing electrical signals), a plurality of electrodes separated from one another by dielectric walls. The plurality of electrodes have smooth and planarized electrode surfaces. The method further includes depositing a template layer on the electrode surfaces and the dielectric walls; patterning the template layer to define a template within the template layer; forming a patterned component on a planarized electrode surface of an electrode of the plurality of electrodes based on the template; depositing and patterning a hard mask, the hard mask configured to protect the patterned component and the planarized electrode surfaces; selectively etching away the dielectric walls to form a plurality of gaps, wherein respective gaps of the plurality of gaps are disposed between adjacent electrodes of the plurality of electrodes; and removing the hard mask.

According to one aspect, an atomic object confinement apparatus is provided. In an example embodiment, the atomic object confinement apparatus includes a substrate comprising a plurality of metal routing features; a plurality of electrodes disposed on a surface of the substrate and in electric communication with respective metal routing features of the plurality of metal routing features; and a patterned component formed on an electrode surface of an electrode of the plurality of electrodes.

In an example embodiment, the electrode is one of a control electrode or a radio frequency (RF) electrode.

In an example embodiment, the electrode surface has a root mean squared (RMS) roughness of 5 nm or less when measured over length scales of at least 50 microns.

In an example embodiment, least a portion of the electrode surface has a reflectivity of at least 70% for light of a selected frequency range.

In an example embodiment, the at least a portion of the electrode surface is a recessed cap.

In an example embodiment, the atomic object confinement apparatus further includes a plurality of gaps, respective gaps of the plurality of gaps disposed between adjacent electrodes of the plurality of segmented electrodes, wherein each gap of the plurality of gaps has a depth to width ratio of at least 0.5.

In an example embodiment, the depth to width ratio is in a range of 0.9 to 2.

In an example embodiment, the atomic object confinement apparatus further includes at least one window post embedded within the segmented electrode, wherein the at least one window post comprises a dielectric material that is transparent for at least a selected range of frequencies of light.

In an example embodiment, the at least one window post is optically aligned with the patterned component.

In an example embodiment, the electrode surface comprises a recessed cap comprising a material that is conductive and transparent for light of at least the selected range of frequencies of light.

In an example embodiment, respective exposed surfaces of the plurality of electrodes define a plane that forms an angle with a plane defined by a surface of the substrate and the angle measures one degree or less.

In an example embodiment, the patterned component is formed of an electrically conductive material.

In an example embodiment, the patterned component is a metasurface and the metasurface comprises a plurality of pillars that extend a feature height out from the electrode surface or a plurality of holes that extend a feature depth into the electrode surface.

In an example embodiment, the patterned component is a metasurface and the metasurface comprises a plurality or an array of holes the extend a feature depth in the electrode surface.

In an example embodiment, either the plurality of pillars have varying heights or the plurality or array of holes have varying depths.

According to another aspect, a method for fabricating an atomic object confinement apparatus is provided. In an example embodiment, the method includes forming, on a surface of a substrate, a plurality of electrodes separated from one another by dielectric walls, the plurality of electrodes having planarized electrode surfaces; depositing a template layer on the electrode surfaces and the dielectric walls; patterning the template layer to define a template within the template layer; forming a patterned component on a planarized electrode surface of an electrode of the plurality of electrodes based on the template; depositing and patterning a hard mask, the hard mask configured to protect the patterned component and the planarized electrode surfaces; selectively etching away (through openings in the hard mask) the dielectric walls to form a plurality of gaps, wherein respective gaps of the plurality of gaps are disposed between adjacent electrodes of the plurality of electrodes; and removing the hard mask.

In an example embodiment, forming the patterned component on the planarized electrode surface based on the template comprises one of depositing a metasurface material layer on the template to form a plurality of pillars that collectively define a metasurface, or etching a plurality of holes into the planarized electrode surface using the template as a mask, the plurality of holes collectively defining the metasurface.

In an example embodiment, the metasurface material layer is deposited with an overburden and the method further comprises one of after removal of the hard mask, removing the overburden, or prior to depositing and forming the hard mask, removing the overburden, or using the overburden as the hard mask.

In an example embodiment, the metasurface material layer comprises a metasurface material and the metasurface material layer is electrically conductive oxide.

In an example embodiment, the metasurface material is indium tin oxide (ITO).

In an example embodiment, the metasurface material layer is deposited using a conformal deposition process.

In an example embodiment, the method further includes removing the template layer.

In an example embodiment, each gap of the plurality of gaps has a depth to width ratio of at least 0.5.

In an example embodiment, the depth to width ratio is in a range of 0.9 to 2.

In an example embodiment, forming the template within the template layer includes using a lithographic process to form the template within the template layer.

In an example embodiment, the lithographic process is a greyscale lithographic process.

In an example embodiment, forming the plurality of segmented electrodes having planarized electrode surfaces includes performing a chemical mechanical polishing (CMP) process on the plurality of segmented electrodes and dielectric walls.

In an example embodiment, the template layer comprises at least one of a resist material, an oxide, amorphous silicon (aSi), germanium, or a material including germanium.

In an example embodiment, a window post is embedded within the segmented electrode, the window post comprises a material that is transparent for at least a selected range of frequencies of light, and the window post is optically aligned with the patterned component.

In an example embodiment, the method further includes forming a recessed cap that is at least partially aligned with the window post, the recessed cap comprising a capping component that is electrically conductive and transparent for light of at least a selected range of frequencies of light.

In an example embodiment, the template layer is patterned to define two or more templates within the template layer, each of the templates being on respective electrode surface of a respective segmented electrode of the plurality of electrodes.

In an example embodiment, the method further includes forming a recessed cap in the electrode surface prior to forming the patterned component thereon, the patterned component being disposed on the recessed cap.

In an example embodiment, the recessed cap comprises a capping component that is conductive and one of (a) has a reflectivity of 70% or more for light of a selected range of frequencies of light such that the patterned component acts at least in part like a mirror, or (b) is transparent for light of the selected range of frequencies of light such that the patterned component acts at least in part like a lens or a diffractive element.

According to another aspect, a system comprising a confinement apparatus of an example embodiment and/or that is fabricated using a method disclosed herein is provided.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 provides block diagram of an example system comprising an atomic object confinement apparatus, in accordance with an example embodiment.

FIG. 2 provides a top view of at least a portion of an example atomic object confinement apparatus, in accordance with an example embodiment.

FIG. 3 provides a flowchart illustrating various processes and/or procedures of fabricating an atomic object confinement apparatus, in accordance with an example embodiment.

FIGS. 4A-4M illustrate various steps of fabricating an atomic object confinement apparatus, in accordance with various embodiments.

FIG. 5 provides a flowchart illustrating various processes and/or procedures of forming a recessed cap, in accordance with various embodiments.

FIGS. 6A-6E illustrate various steps of fabricating an atomic object confinement apparatus that includes a recessed cap, in accordance with various embodiments.

FIG. 7 provides a schematic diagram of an example controller of a system comprising a quantum object confinement apparatus configured for confining atomic objects therein, in accordance with an example embodiment.

FIG. 8 provides a schematic diagram of an example computing entity of a system comprising a quantum object confinement apparatus that may be used in accordance with an example embodiment.

### DETAILED DESCRIPTION OF SOME EXAMPLE EMBODIMENTS

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. The terms “generally” and “approximately” refer to within applicable engineering and/or manufacturing tolerances and/or within user measurement capabilities, unless otherwise indicated. Like numbers refer to like elements throughout.

In various scenarios, atomic objects are confined by an atomic object confinement apparatus (also referred to as a confinement apparatus herein). In various embodiments, an atomic object is an ion; atom; ionic, molecular, and/or multipolar molecule; quantum dot; quantum particle; group, crystal, and/or combination thereof (e.g., an ion crystal comprising two or more ions); and/or the like. In an example embodiment where the atomic objects are ions and/or ion crystals, the confinement apparatus is an ion trap, such as a surface ion trap, Paul ion trap, and/or the like. In various other embodiments, the confinement apparatus is an apparatus configured to confine atomic objects and comprises a plurality of surface electrodes. For example, in various embodiments, the confinement apparatus comprises a substrate that may include one or more layers including one or more vias, routing and/or interconnect layers, photonic/optical layers, and/or the like. A plurality of segmented surface electrodes is formed on the substrate. In various embodiments, at least one metasurface is formed on a planarized electrode surface of a segmented electrode of the plurality of segmented surface electrodes.

In various embodiments, the atomic objects confined by a confinement apparatus are used to perform experiments, controlled quantum state evolution, quantum computations, and/or the like. For example, the confinement apparatus may be part of an atomic system, such as an atomic clock, spectroscopic and/or mass analyzer system, quantum charge-coupled device (QCCD)-based quantum computer, and/or the like. The at least one metasurface may be used to provide optical beams and/or signals to respective locations defined at least in part by the confinement apparatus such that the optical beams and/or signals may interact with atomic objects disposed and/or confined at the respective locations. For example, in some embodiments, the at least one metasurface is at least partially aligned with one or more photonics elements of a photonics layer of the substrate housing the confinement apparatus and the metasurface is configured to assist in directing light from the one or more photonics elements toward an atomic object location. In another example, the metasurface may be formed on a metal layer configured to act as a reflector and light may be provided (e.g., by optical and/or photonic elements that are not part of the substrate housing the confinement apparatus) such that the metasurface acts at least partially like a mirror to reflect and direct the light toward an atomic object location. For example, in various embodiments, the composition of the metal layer may be selected so as to be configured to be reflective (e.g., have a reflectivity of 70% or more) for light of a selected frequency range (such as Al for visible wavelengths, or Cu for near-IR to near-visible wavelengths).

In an example embodiment, the at least one metasurface is configured to aid in the collection and/or detection of light emitted and/or fluoresced by atomic objects disposed and/or confined at the respective locations.

For confinement apparatuses having integrated photonic elements (such as metasurfaces), positioning the optical components with respect to the electrical components (e.g., surface electrodes, etc.) can be difficult. For example, a significant amount of the surface of the confinement apparatus may be filled with the segmented electrodes used to generate the trapping potential configured to confine the atomic objects. Additionally, any electrical charge that becomes trapped on the optical components formed on the surface of the confinement apparatus (e.g., on metasurfaces formed on the surface of the confinement apparatus) could negatively affect operation of the confinement apparatus. Therefore, technical problems exist regarding the incorporation of integrated photonic elements (such as metasurfaces) in confinement apparatuses.

Moreover, conventional methods for forming surface electrodes of a confinement apparatus, such as metal lift off and direct metal etching tend to result in surface electrodes with significant surface topology. For example, the exposed electrode surface of the segmented surface electrodes formed through conventional surface electrode fabrication processes are not planar and/or smooth on a nanometer size scale. For example, conventional surface electrode fabrication processes include micron scale topological features. Fabrication of nano-scale features of a metasurface on a surface having micron scale topological features is technically quite difficult. Moreover, in some instances, the topology of the exposed surface of the surface electrodes is significant enough to affect the optical properties of a metasurface and/or other optical component formed on the electrode surface of the segmented surface electrodes. Therefore, additional technical problems exist regarding how to form metasurfaces on electrode surfaces of segmented surface electrodes such that the metasurfaces have predictively reliable optical properties.

Embodiments of the present disclosure provide technical solutions to these technical problems. Various embodiments provide confinement apparatuses, systems comprising confinement apparatuses, and/or methods for fabricating confinement apparatuses that include metasurfaces formed on (and/or in) the electrode surfaces of respective segmented electrodes of the confinement apparatus. In various embodiments, the segmented electrodes are formed using a damascene mask process. For example, dielectric walls are formed on a substrate. An electrode material layer is deposited on the substrate and the dielectric walls and then planarized. The planarization may be performed by chemical mechanical polishing (CMP), a patterned etch, and/or thin film trimming. For example, in certain embodiments, CMP may be performed and then a thin film trimming process may be performed to address residual thickness variation.

The planarized electrode surfaces have a root mean square (RMS) roughness of 5 nm or less (e.g., 3 nm or less) when measured over length scales of at least 50 microns. For example, the planarized electrode surface are free of topological features greater than 10-20 nm, in various embodiments. Thus, the topology of the surface electrodes is sufficiently smooth that the topology of the surface electrodes does not affect the optical properties of the metasurfaces. Moreover, in various embodiments, the planarized electrode surfaces are flat and define a plane that is parallel to a plane defined by the surface of the substrate. For example, an angle between the plane defined by the planarized electrode surfaces and the plane defined by the surface of the substate on which the plurality of electrodes is formed is less than 1 degree.

A template layer is deposited on the planarized electrode surfaces. The template layer is then patterned using lithographic processes, masked etching, greyscale lithographic processes, and/or the like to form metasurface templates therein. A metasurface material layer may then be conformally deposited on the template layer to form respective metasurfaces in the respective metasurface templates. The dielectric walls are then removed using a selective etch to form gaps between the segmented surface electrodes such that the electrodes are electrically isolated from one another by the gaps. The metasurfaces may be protected by hard mask while the selective etching is performed to form the gaps. By enabling the metasurfaces to be located on the segmented electrodes on the surface of the confinement apparatus, a variety of options for the positioning of the metasurfaces is provided. In some embodiments, the template layer is patterned using a greyscale lithographic process such that the metasurface material layer may be patterned to include features (e.g., pillars, holes, and/or the like) of different heights/depths.

Furthermore, in various embodiments, the metasurfaces are formed of a metasurface material. In an example embodiment, the metasurface material is electrically conductive. For example, the metasurface material is a transparent conducting oxide (TCO), such as indium tin oxide (ITO), in various embodiments. Thus, the metasurfaces are grounded by being formed on the segmented electrodes and will not trap excess charges on the surface of the confinement apparatus.

Additionally, by enabling the metasurfaces to be disposed on the surfaces of the electrodes, various embodiments provide a significant increase in flexibility regarding placement of the metasurfaces and in how manipulation signals (e.g., laser beams and/or pulses) are provided to atomic object locations (which are defined at least in part by the atomic object confinement apparatus) and the atomic objects located thereat. By enabling manipulation signals to be provided to atomic object locations using out-of-plane beam paths (e.g., beam paths that are not parallel to a plane defined by the surface of the atomic object confinement apparatus), various embodiments enable the confinement apparatus to be increased in size to be able to confine more atomic objects (e.g., resulting in more qubits available to a quantum computer including the confinement apparatus, for example) and/or to define more atomic object locations at which controlled quantum state evolution of the atomic objects may be performed.

Moreover, the flexibility in placement of metasurfaces and the use of metasurfaces to direct out-of-plane propagating manipulation signals toward atomic object locations reduces the precision with which external beam delivery systems need to be aligned with their target locations. This enables for improved qubit performance (e.g., improved gate fidelity) since small misalignments of the external beam delivery system will not result in large differences in the (e.g., the amplitude of) the manipulation signal provided to an atomic object location.

Various embodiments therefore provide improvements to the technical fields of confinement apparatuses, confinement apparatuses including integrated photonic elements, systems including confinement apparatuses (including confinement apparatus having integrated photonic elements), methods for fabricating confinement apparatuses (including confinement apparatus having integrated photonic elements), and quantum computing (e.g., quantum charge-coupled device (QCCD)-based quantum computing).

### Example System Comprising an Atomic Object Confinement Apparatus

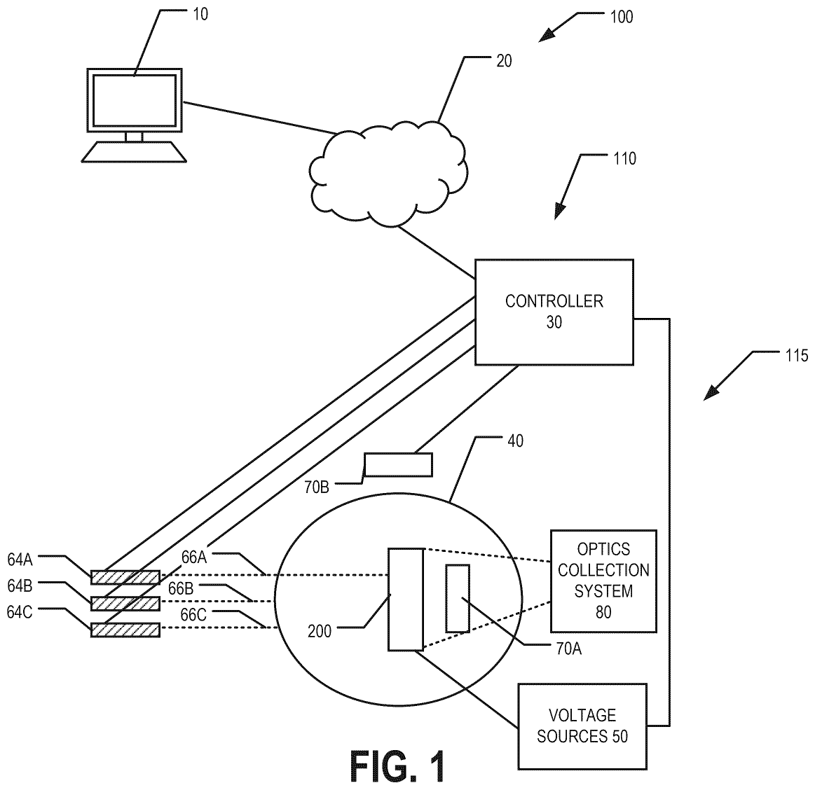

As noted above, various confinement apparatuses of various embodiments may be incorporated into various atomic systems, quantum systems, and/or the like. For example, various embodiments provide a system 100 comprising an atomic object confinement apparatus 200, as shown in FIG. 1. The atomic object confinement apparatus 200 is configured to confine a plurality of atomic objects such that the respective quantum states of the atomic objects may be manipulated, evolved in a controlled manner (e.g., in accordance with a quantum circuit), and/or the like.

For example, atomic objects may be used as the qubits of a quantum computer 110. For example, quantum operations (one qubit quantum logic gates, two qubit quantum logic gates, initialization, reading/detecting operations, and/or the like) may be performed on atomic objects confined by the confinement apparatus 200 and/or system 100 comprising the confinement apparatus. For example, the confinement apparatus 200 is configured to maintain one or more atomic objects at respective locations and/or transport atomic objects between respective locations such that the quantum operation may be performed on the one or more atomic objects.

In various embodiments, the system 100 comprising the confinement apparatus 200 comprises one or more manipulation sources 64 (e.g., 64A, 64B, 64C) configured to provide manipulation signals (e.g., laser beams and/or pulses, microwave signals/fields, and/or the like) such that the manipulation signals interact with one or more atomic objects confined at particular locations defined at least in part by the confinement apparatus. In various embodiments, the system 100 comprising the confinement apparatus 200 comprises one or more magnetic field sources 70 (e.g., 70A, 70B) configured to provide a controlled magnetic field and/or magnetic field gradient at particular locations defined at least in part by the confinement apparatus for use in performing one or more quantum operations on one or more atomic objects confined by the confinement apparatus 200. In various embodiments, the system 100 comprising the confinement apparatus 200 comprises an optics collection system configured to collect and/or detect light and/or photons emitted by one or more atomic objects disposed at the particular locations defined at least in part by the confinement apparatus.

In an example embodiment, the system 100 comprising the confinement apparatus 200 is and/or includes a quantum charge-coupled device (QCCD)-based quantum computer 110. For example, one or more of the atomic objects confined by the confinement apparatus 200 may be used as qubits of the quantum computer 110.

In various embodiments, the system 100 comprises a classical and/or semiconductor-based computing entity 10 and a quantum computer 110. In various embodiments, the quantum computer 110 comprises a controller 30 and a quantum processor 115. In various embodiments, the quantum processor 115 comprises a cryostat and/or vacuum chamber 40 enclosing a confinement apparatus 200, one or more manipulation sources 64 (e.g., 64A, 64B, 64C), one or more voltage sources 50, one or more magnetic field sources 70 (e.g., 70A, 70B), an optics collection system 80, and/or the like. In various embodiments, the controller 30 is configured to control the operation of (e.g., control one or more drivers configured to cause operation of) the manipulation sources 64, voltage sources 50, magnetic field sources 70, a vacuum system and/or cryogenic cooling system (not shown), and/or the like. In various embodiments, the controller 30 is configured to receive signals (e.g., electrical signals) generated and provided by the optics collection system 80.

In an example embodiment, the one or more manipulation sources 64 may comprise one or more lasers (e.g., optical lasers, microwave sources and/or masers, and/or the like) or another manipulation source. In various embodiments, the one or more manipulation sources 64 are configured to manipulate and/or cause a controlled quantum state evolution of one or more atomic objects confined by the confinement apparatus 200. For example, a first manipulation source 64A is configured to generate and/or provide a first manipulation signal and a second manipulation source 64B is configured to generate and/or provide a second manipulation signal, where the first and second manipulation signals are configured to perform one or more quantum operations (single qubit gates, two-qubit gates, cooling, initialization, reading/detection, and/or like) on atomic objects confined by the confinement apparatus.

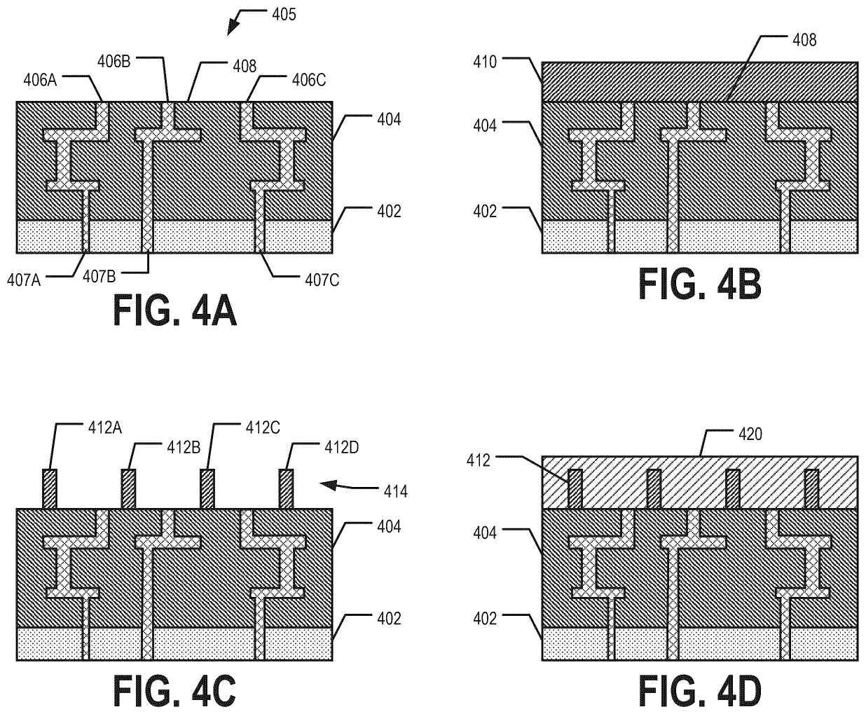

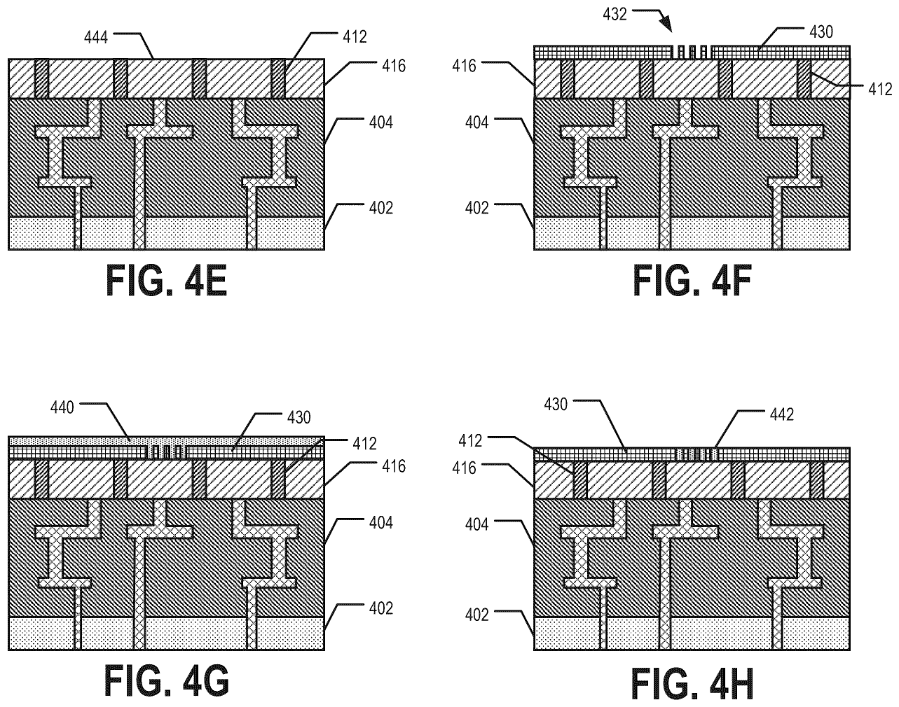

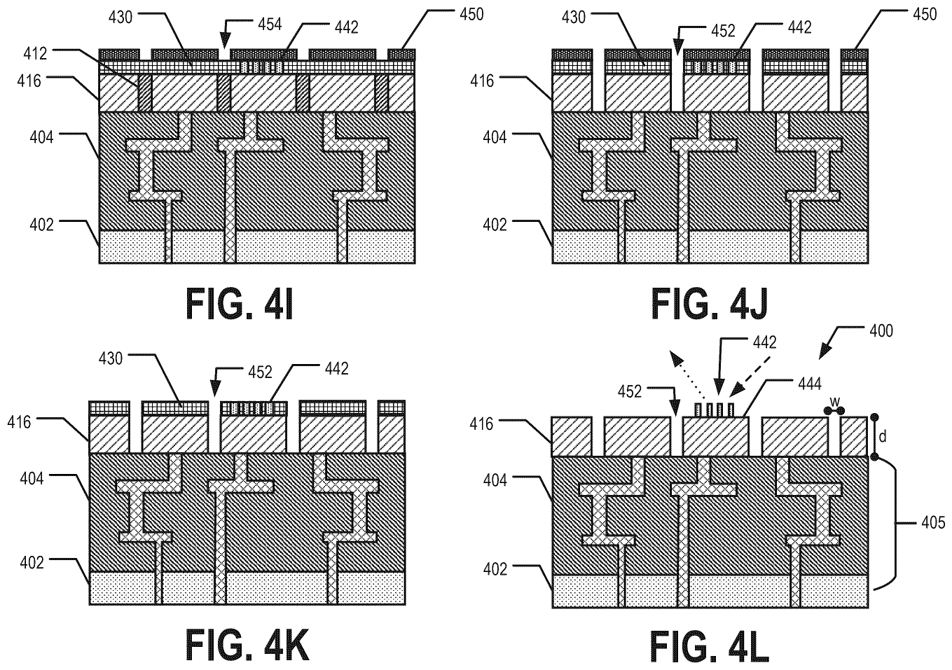

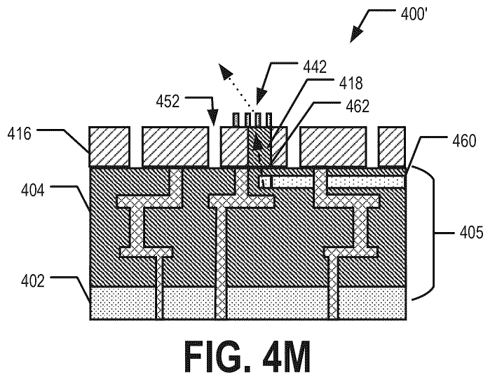

In an example embodiment, the one or more manipulation sources 64 each provide a manipulation signal (e.g., laser beam and/or the like) to one or more regions of the atomic object confinement apparatus 200 via corresponding beam path systems 66 (e.g., 66A, 66B, 66C). In various embodiments, at least one beam path system 66 comprises a modulator configured to modulate the manipulation signal being provided to the confinement apparatus 200 via the beam path system 66. In various embodiments, the manipulation sources 64, modulator, and/or other components of the quantum computer 110 are controlled by the controller 30. In various embodiments, at least one beam path system 66A comprises one or more integrated photonic elements formed in (one or more photonics layers 460 of) a substrate of the confinement apparatus (e.g., waveguide 464 and coupler 462 as shown in FIG. 4M) and/or on a surface of the confinement apparatus (e.g., metasurface 442). For example, the metasurface 442 may be part of one or more beam path systems configured to direct manipulation signals (e.g., laser beams and/or pulses) toward a corresponding atomic object location.

For example, in various embodiments, a beam path system 66 includes one or more photonic elements (e.g., waveguides, beam splitters, grating couplers, modulators, polarizers, etc.) integrated on the same substrate as the confinement apparatus and/or a photonic integrated circuit (PIC) disposed within the cryostat and/or vacuum chamber 40. In an example embodiment, a beam path system 66 includes one or more optical fibers configured to transport manipulation signals at least partially from a manipulation source 64 to a PIC formed on the same substrate as the confinement apparatus and/or another substrate configured to be secured with respect to the confinement apparatus (e.g., packaged with the substrate housing the confinement apparatus). In an example embodiment, one or more of the manipulation sources 64 are disposed within the cryostat and/or vacuum chamber 40 (e.g., on the same substrate as the confinement apparatus and/or another substrate configured to be secured with respect to the confinement apparatus).

In various embodiments, the confinement apparatus 200 is an ion trap, such as a surface ion trap, Paul ion trap, and/or the like. In various embodiments, the atomic objects are ions; atoms; ion crystals and/or groups; atomic crystals and/or groups; charged, neutral, and/or multipolar molecules; quantum dots; quantum particles; groups, crystals, and/or combinations thereof (e.g., ion crystals); and/or the like. In various embodiments, the confinement apparatus 200 is an appropriate confinement apparatus for confining the atomic objects of the embodiment.

In various embodiments, the quantum computer 110 comprises one or more voltage sources 50. For example, the voltage sources may be arbitrary wave generators (AWG), digital to analog converters (DACs), and/or other voltage signal generators. For example, the voltage sources 50 may comprise a plurality of longitudinal voltage drivers and/or voltage sources and/or at least one RF driver and/or voltage source. The voltage sources 50 may be electrically coupled to the corresponding potential generating elements and/or surface electrodes (e.g., control electrodes and/or RF electrodes) of the confinement apparatus 200, in an example embodiment.

In various embodiments, the quantum computer 110 comprises one or more magnetic field sources 70 (e.g., 70A, 70B). For example, the magnetic field source may be an internal magnetic field source 70A disposed within the cryogenic and/or vacuum chamber 40 and/or an external magnetic field source 70B disposed outside of the cryogenic and/or vacuum chamber 40. In various embodiments, the magnetic field sources 70 comprise permanent magnets, Helmholtz coils, electrical magnets, and/or the like. In various embodiments, the magnetic field sources 70 are configured to generate a magnetic field and/or magnetic field gradient at one or more regions of the confinement apparatus 200 that has a particular magnitude and a particular magnetic field direction in the one or more regions of the confinement apparatus 200.

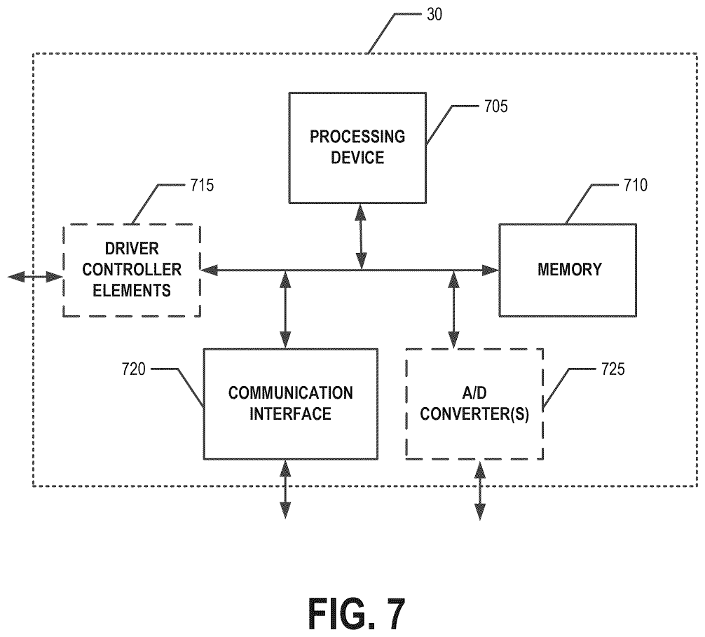

In various embodiments, the quantum computer 110 comprises an optics collection system 80 configured to collect and/or detect photons (e.g., stimulated emission) generated by atomic objects disposed in respective locations (e.g., during reading/detection operations) defined at least in part by the confinement apparatus. The optics collection system 80 may comprise one or more optical elements (e.g., lenses, mirrors, waveguides, fiber optics cables, metasurfaces, and/or the like) and one or more photodetectors. In an example embodiment, the optics collection system 80 comprises a metasurface formed on a segmented electrode of the confinement apparatus that is configured to direction light emitted by an atomic object toward a photodetector. In various embodiments, the photodetectors may be photodiodes, photomultipliers, charge-coupled device (CCD) sensors, complementary metal oxide semiconductor (CMOS) sensors, Micro-Electro-Mechanical Systems (MEMS) sensors, and/or other photodetectors that are sensitive to light at an expected fluorescence wavelength of the atomic objects. While the optics collection system 80 is illustrated as being outside of the cryostat and/or vacuum chamber 40, in various embodiments, one or more optical elements and/or the one or more photodetectors of the optics collection system may be disposed within the cryostat and/or vacuum chamber 40. In various embodiments, the detectors may be in electronic communication with the controller 30 via one or more A/D converters 725 (see FIG. 7) and/or the like.

In various embodiments, a computing entity 10 is configured to allow a user to provide input to the quantum computer 110 (e.g., via a user interface of the computing entity 10) and receive, view, and/or the like output from the quantum computer 110. The computing entity 10 may be in communication with the controller 30 of the quantum computer 110 via one or more wired or wireless networks 20 and/or via direct wired and/or wireless communications. In an example embodiment, the computing entity 10 may translate, configure, format, and/or the like information/data, quantum computing algorithms (e.g., quantum circuits), and/or the like into a computing language, executable instructions, command sets, and/or the like that the controller 30 can understand, execute, and/or implement.

In various embodiments, the controller 30 is configured to control the voltage sources 50, magnetic field sources 70, cryogenic system and/or vacuum system controlling the temperature and/or pressure within the cryogenic and/or vacuum chamber 40, manipulation sources 64, and/or other systems controlling various environmental conditions (e.g., temperature, pressure, and/or the like) within the cryogenic and/or vacuum chamber 40, configured to manipulate and/or cause a controlled evolution of quantum states of one or more atomic objects within the confinement apparatus, and/or read and/or detect a quantum (e.g., qubit) state of one or more atomic objects within the confinement apparatus 200. For example, the controller 30 may cause a controlled evolution of quantum states of one or more atomic objects within the confinement apparatus to execute a quantum circuit and/or algorithm. For example, the controller 30 may read and/or detect quantum states of one or more atomic objects within the confinement apparatus at one or more points during the execution of a quantum circuit. In various embodiments, the atomic objects confined by the confinement apparatus are used as qubits of the quantum computer 110.

### Example Atomic Object Confinement Apparatus

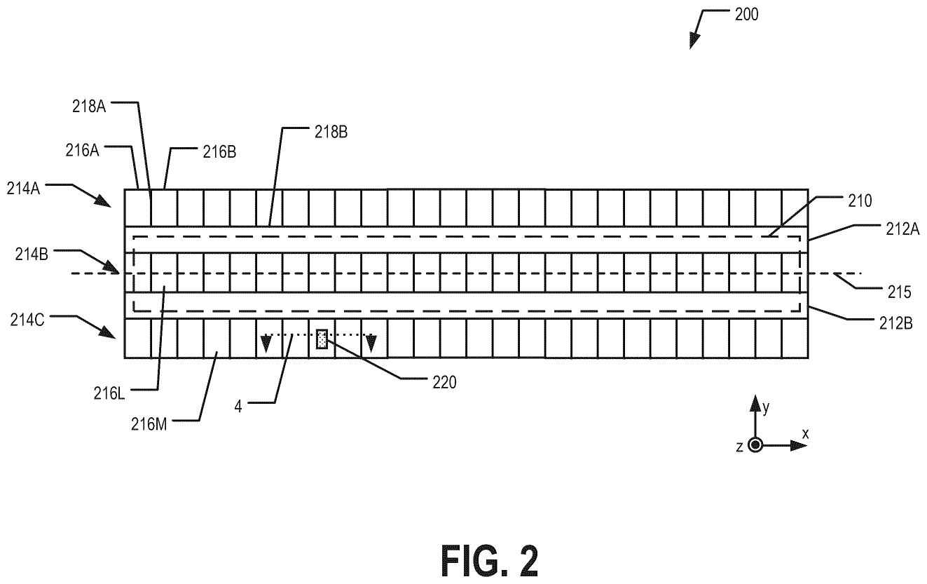

FIG. 2 provides a top view of at least a portion of an example confinement apparatus 200 that may be used to confine one or more atomic objects. For example, in the illustrated embodiment, the confinement apparatus is an ion trap (e.g., a surface ion trap) and the atomic objects are ions and/or ion crystals. The linear portion of the example confinement apparatus 200 may be part of a larger linear geometry of the confinement apparatus or may be part of a two-dimensional or three-dimensional geometry of the confinement apparatus, in various embodiments.

In an example embodiment, the confinement apparatus 200 (e.g., surface ion trap) is fabricated as part of an ion trap chip and/or part of an ion trap apparatus and/or package. In an example embodiment, the confinement apparatus 200 is at least partially defined by a number of RF electrodes 212 (e.g., 212A, 212B). While the RF electrodes 212 are illustrated as generally rectangular, in various embodiments, the RF electrodes 212 may have various geometries, as appropriate for the application. In various embodiments, the confinement apparatus 200 is at least partially defined by a number of longitudinal sequences of control electrodes 214 (e.g., 214A, 214B, 214C). Each longitudinal sequence of control electrodes 214 comprises a plurality of control electrodes 216 (e.g., 216A, 216B, . . . , 216L, 216M). While the control electrodes 216 are illustrated as generally rectangular, in various embodiments, the control electrodes 216 may have various geometries, as appropriate for the application. In an example embodiment, each control electrode 216 and/or at least a non-empty subset of the control electrodes 216 may be operated independently via the application of control signals thereto. In an example embodiment, at least some of the control electrodes 216 are operated via application of a broadcast control signal. In an example embodiment, the confinement apparatus 200 is a surface Paul trap with symmetric RF electrodes 212. In various embodiments, the RF electrodes 212 and the control electrodes 216 generate potentials and/or fields that are experienced by atomic objects within respective confinement regions of the confinement apparatus 200. In particular, the RF electrodes 212 may be configured to define the respective confinement regions 210 of the confinement apparatus 200 and the control electrodes 216 may be configured to at least partially control movement and/or motion of atomic objects within the respective confinement regions. For example, the RF electrodes 212 may define an RF null axis 215, along which the atomic objects are confined. For example, the confinement apparatus 200 at least partially defines a plurality of atomic object locations that are generally located along respective RF null axes 215 of respective confinement regions 210.

A gap 218A is disposed between control electrodes 216. For example, control electrodes 216A, 216B are adjacent electrodes as the control electrodes 216A, 216B are separated only by the gap 218A (e.g., there are no other electrodes between the adjacent control electrodes 216A, 216B). In various embodiments, a gap 218B is present between a respective control electrode 216 and an adjacent RF electrode 212. In various embodiments, the gap 218 (e.g., 218A, 218B) has a depth d to width w ratio of at least 0.5. In various embodiments, the depth d to width w ratio of the gap 218 is greater than 0.9, greater than 1.1, greater than 1.5, in a range of 1.0 to 3, in a range of 1.0 to 5, in a range of 1.1 to 5, and/or the like.

In various embodiments, a metasurface 220 is formed on an electrode surface of one the control electrodes 216 (e.g., 216A, 216L, 216M and/or any other of the control electrodes 216) and/or on a surface of an RF electrode 212. In various embodiments, a metasurface is formed of an array of metastructures (e.g., nanometer and/or micron scale pillars and/or columns or holes and/or depressions). The optical and/or photonic properties of the metasurface are controlled by the geometry, size, arrangement, and/or orientation of the plurality of metastructures that form the array of metastructures. In various embodiments, the metastructures are nanometer-scale structures. In various embodiments, the metastructures are sub-wavelength structures. In various embodiments, a subwavelength structure is a structure that extends out from the planarized electrode surface and/or has a diameter/major axis/minor axis/side length that is less than the wavelength of signals that are intended to be incident on the array of metastructures and/or that is less than the wavelength of a signal intended to be emitted by the array of metastructures. For example, the metasurface 220 comprises a plurality of pillars and/or columns formed on the planarized electrode surface of a control electrode 216 and/or an RF electrode. In another example embodiment, the metasurface 220 comprises a plurality and/or array of holes and/or recesses formed in the planarized electrode surface (and/or in a recessed cap defined therein and/or in a capping layer formed thereon) of a control electrode 216 and/or an RF electrode 212.

In some embodiments, the metasurface 220 comprises a plurality of pillars/columns and/or holes/recess where each feature (e.g., pillar, column, hole, or recess) has the height/depth that is substantially the same when measured normal to plane defined by the surfaces of the electrodes 444. For example, each feature of the metasurface 220 may extend a same distance into or out from the surface of the electrode 444 hosting the metasurface 220. In some embodiments, greyscale lithography is used to pattern the metasurface 220 such that the heights/depths of the features of the metasurface are not uniform. For example, various features of the metasurface 220 may extend various distances into or out from the surface of the electrode 444 hosting the metasurface 220. In other words, the metasurface 220 may include at least a first feature and a second feature where the first feature extends a different distance into or out from the surface of the electrode 444 than the second feature.

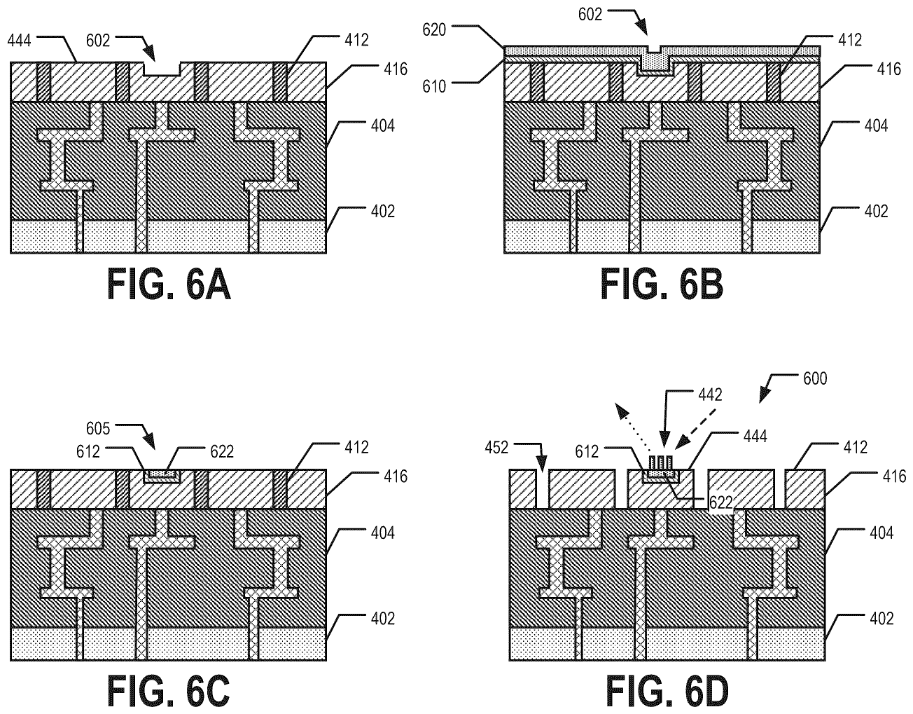

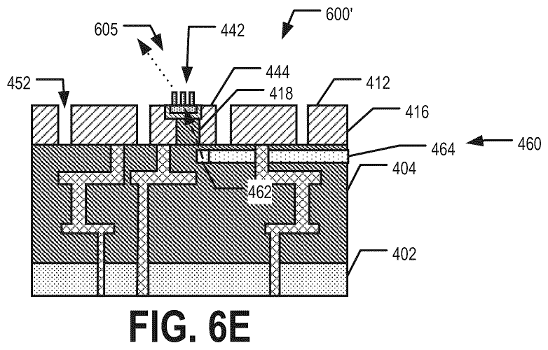

FIGS. 4L and 4M illustrate cross-sectional views of portions of some example embodiments of an atomic object confinement apparatus 400, 400′. For example, FIG. 4L is a cross section taken at line 4 in FIG. 2. FIGS. 6D and 6E illustrate cross-sectional views of portions of some example embodiments of an atomic object confinement apparatus 600, 600′ The metasurfaces 442 of the atomic object confinement apparatus 600, 600′ are formed on a recessed cap 605.

For example, the atomic object confinement apparatus 400, 600 includes a metasurface 442 that acts, at least in part, as a mirror. For example, the metasurface 442 of the atomic object confinement apparatus 400, 600 is formed on a reflective and/or metal surface such that when light is incident on the metasurface 442, induced light is emitted by the metasurface 442 that is directed away from the surface of the electrode 444 and toward a corresponding atomic object location. The atomic object confinement apparatus 400′, 600′ includes a metasurface 442 that acts, at least in part, as a lens or diffractive element. For example, the atomic object confinement apparatus 400′, 600′ includes one or more photonic layers integrated within the substrate 405 housing the confinement apparatus such that one or more photonic elements of the one or more photonic layers provides light to the metasurface 442 from below the surface of the substrate 405. The metasurface 442 emits induced light that is directed toward a corresponding atomic object location.

In various embodiments, a confinement apparatus 400, 400′, 60, 600′ includes a substrate 405 and a plurality of segmented electrodes 416 formed on the substrate 405. For example, the control electrodes 216 may be segmented electrodes 416. The substrate 405 comprises a plurality of metal routing features, such as a plurality of vias 406 (e.g., 406A, 406B, 406C), through silicon vias (TSVs) 407 (e.g., 407A, 407B, 407C, interconnects, and/or the like, as shown in FIG. 4A. For example, the substrate 405 may include a variety of interconnect layers, vias, TSVs, integrated photonic layers, and/or the like as appropriate for the confinement apparatus design. Adjacent electrodes of the plurality of segmented electrodes 416 are separated from one another by gaps 452.

In various embodiments, the exposed electrode surfaces 444 are smooth, planar surfaces. For example, the exposed electrode surface 444 is considered smooth because the electrode surface 444 does not include any topological features that are larger than 20 nm. For example, the electrode surface 444 has an RMS roughness of 5 nm or less (e.g., 3 nm or less) when measured over length scales of at least 50 microns. Moreover, in various embodiments, the planarized electrode surfaces are flat and define a plane that is parallel to a plane defined by the surface of the substrate. For example, an angle between the plane defined by the planarized electrode surfaces and the plane defined by the surface of the substate on which the plurality of electrodes is formed is less than 1 degree. For example, in various embodiments, the electrode surface 444 is planarized via chemical mechanical polishing (CMP), patterned etching, and/or thin film trimming. For example, in certain embodiments, CMP may be performed and then a thin film trimming process may be performed to address residual thickness variation.

A metasurface 442 is formed on a planarized electrode surface 444. In various embodiments, the metasurface 442 is an optical metasurface. In various embodiments, the metasurface 442 comprises an array of pillars or columns formed of a metasurface material. In various embodiments, the metasurface material is a conductive material. In various embodiments, the metasurface material is a transparent conductive oxide (TCO), such as indium tin oxide (ITO) and/or the like.

The metasurface 442 is configured such that a beam of light may be incident thereon, as shown by the dashed line. The light interacts with the metasurface such that an induced beam is provided, as shown by the dotted line. The induced beam may have various optical properties that are controlled by metasurface 442, such as polarization, wavelength, relative phase delay, direction of propagation, beam profile, focal point, and/or the like.

In various embodiments, such as that illustrated in FIG. 4L, the gaps 452 between the segmented electrodes 416 are formed via anisotropic etching such that the gaps 452 do not undercut the segmented electrodes 416. In an example embodiment, the confinement apparatus 400 includes gaps 452 that undercut the adjacent segmented electrodes 416.

In an example embodiment, such as that illustrated in FIG. 4M, the confinement apparatus 400′ includes one or more photonics layers 460 that each include respective integrated photonic elements such as a waveguide 464 and a coupler 462. For example, in various embodiments, one or more segmented electrodes 416 include respective window posts 418. For example, window post 418 is a post or pillar of dielectric material that is transparent to light of at least a selected frequency range. For example, a dielectric window post 418 may extend through the bulk material of a segmented electrode 416 to allow light to pass therethrough. The conductive material of the segmented electrode 416 was deposited around the window post 418 such that the window post 418 is embedded within the segmented electrode 416.

In various embodiments, the coupler 462 is aligned with the window post 418 such that the coupler 462 couples light out of the waveguide 464 and out through the window post 418, as shown by the dashed arrow. The light is incident on the metasurface 442, and the interaction of the light and the metasurface 442 causes an induced beam, as shown by the dotted line, to be emitted. The induced beam may have various optical properties that are controlled by metasurface 442, such as polarization, wavelength, relative phase delay, direction of propagation, beam profile, focal point, and/or the like. As shown in FIG. 6E, in some embodiments, a window post 418 is capped by a recessed cap 605 formed of a conductive material that is transparent to light of at least a selected frequency range.

In an example embodiment, the coupler 462 is configured to couple light that passed through the metasurface 442 and the window post 418 into the waveguide 464. For example, the metasurface 442 may be configured to direct light incident thereon toward the coupler 462 such that the coupler 462 may couple the light into the waveguide 464 (e.g., for detection by a photodetector of the optics collection system 80).

While various embodiments are described herein as the formation of a metasurface on the surface of an electrode of the confinement apparatus, in various other embodiments, a patterned component may be formed on the surface of an electrode. For example, a pattern component may be formed on and/or in the surface of the electrode using a lithographic technique. In an example embodiment, the pattern component is formed on and/or in the surface of the electrode using a greyscale lithographic technique. For example, the patterned component may be a metasurface, a diffractive optical element (e.g., lens, etc.), photonic alignment marks (e.g., for aligning externally provided beams with respective target locations of the confinement apparatus), and/or the like.

### Example Method of Fabricating a Confinement Apparatus

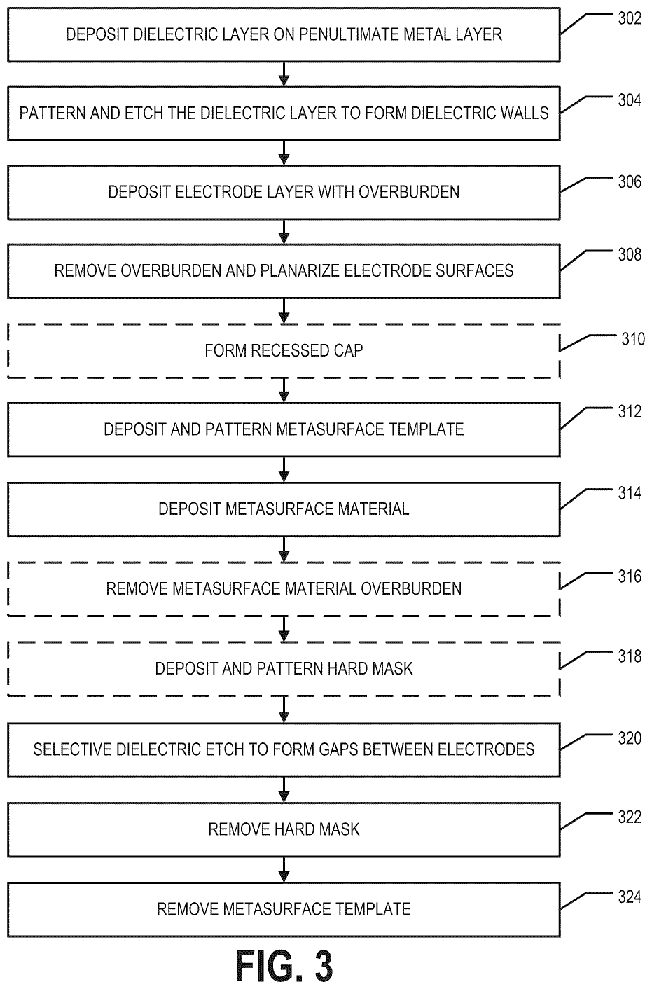

FIG. 3 provides a flowchart illustrating various processes, procedures, operations, and/or the like for fabricating a confinement apparatus 400. FIGS. 4A-4L illustrate cross-sectional views of various steps of fabricating a confinement apparatus 400. FIG. 4M illustrates a cross-sectional view of an alternative embodiment of a confinement apparatus 400′.

In various embodiments, the confinement apparatus 400 is formed on a substrate 405, as shown in FIG. 4A. The substrate 405 comprises The substrate 405 comprises a plurality of metal routing features, such as a plurality of vias 406 (e.g., 406A, 406B, 406C), TSVs 407 (e.g., 407A, 407B, 407C, interconnects, and/or other metal routing features, In various embodiments, the metal routing features are configured to provide voltage and/or current signals to the segmented electrodes 416 when the confinement apparatus 400 is operated. In various embodiments, the substrate 405 includes a variety of interconnect layers, vias, integrated photonic layers, through silicon vias (TSVs), and/or the like. For example, the illustrated substrate 405 includes a wafer portion 402 and an interconnect layer 404 including the plurality of metal routing features (e.g., vias 406, TSVs 407, interconnects, etc.).

In various embodiments, a plurality of segmented electrodes 416 separated by dielectric walls 412 are formed on the substrate 405, an example of which is shown in FIG. 4E. In various embodiments, forming the plurality of segmented electrodes 416 separated by dielectric walls 412 on the substrate 405 includes performance of steps 302-308.

As shown in FIG. 3, at step 302, a dielectric layer 410 is deposited on the penultimate metal layer 408, as shown in FIG. 4B. For example, the dielectric layer 410 is deposited using a chemical vapor deposition (CVD) process in an example embodiment. In an example embodiment, the material of the Dielectric layer 410 is selected to have a low dielectric constant and low dielectric loss at radio frequencies. For example, in various embodiments, the Dielectric layer 410 comprises SiO₂. In some embodiments, the Dielectric layer 410 is deposited using CVD with silane or tetraethyl low-k dielectric materials, such as F-doped SiO₂, C-doped SiO₂, orthosilicate glass, fluorosilicate glass, and/or the like.

In an example embodiment, the dielectric layer 410 is deposited to at least a depth d, which is the intended depth of the gaps 452. In an example embodiment, the depth d of the Dielectric layer 410 is larger or smaller than the intended depth of the gaps 452. In various embodiments, the Dielectric layer 410 is deposited to a depth d that is equal to or greater than the intended thickness of the electrodes (including any capping layer).

At step 304, the dielectric layer 410 is patterned and etched to form a segmented dielectric layer 414 that includes a plurality of dielectric walls 412 (e.g., 412A, 412B, 412C, 412D), as shown in FIG. 4C. In various embodiments, the segmented dielectric layer 414 includes one or more window posts 418. In various embodiments, the dielectric layer 410 is patterned and etched to form the segmented dielectric layer 414 using lithography, masked etching, and/or similar processes. For example, a dry etching process may be used to form the segmented dielectric layer 414 from the un-patterned dielectric layer 410.

In an example embodiment, the segmented dielectric layer 414 includes one or more window posts 418. For example, a window post 418 may be patterned out of the dielectric layer 410.

As shown in FIG. 4D, at step 306, an electrode layer 420 is deposited on the substrate 405 and the segmented dielectric layer 414. In various embodiments, the electrode layer 420 is deposited using a CVD or a physical vapor deposition (PVD) process. In various embodiments, the electrode layer 420 is deposited using a conformal deposition.

In various embodiments, the electrode layer 420 comprises a conductive, low resistivity metal. In various embodiments, the electrode layer 420 comprises a material that may be processed and/or planarized via chemical mechanical polishing (CMP), patterned etching, and/or thin film trimming. For example, in certain embodiments, CMP may be performed and then a thin film trimming process may be performed to address residual thickness variation. For example, in various embodiments, the electrode layer 420 comprises a bulk metal material. In various embodiments, the bulk metal material comprises one or more of copper (Cu), tungsten (W), or aluminum (Al).

In various embodiments, the electrode layer 420 may include more than one material. For example, the electrode layer 420 may include a bulk metal material and a capping conductive material. For example, the electrode layer 420 may include a layer of bulk metal material that is adjacent the substrate 405 and layer of capping conductive material that was deposited onto the layer of bulk metal material. In an example embodiment, the layer of bulk metal material has a thickness in a range of 100 nm to 5 μm. In an example embodiment, the layer of capping conductive material has a thickness in a range of 50 to 500 nm. For example, in an example embodiment, the capping conductive material comprises one or more of niobium (Nb), indium tin oxide (ITO), aluminum zinc oxide (AZO), indium oxide (In₂O₃), titanium nitride (TiN), tantalum nitride (TaN), gold (Au), or platinum (Pt).

In various embodiments, the electrode layer 420 is deposited with an overburden. For example, the electrode layer 420 is deposited to a depth that is greater than the height of the dielectric walls 412. For example, the electrode layer 420 is deposited with an overburden such that there are no holes or empty spaces within the electrode layer 420 and/or at the interfaces between the dielectric walls 412 and/or window posts 418 with the electrode layer 420.

At step 308, the overburden is removed from the electrode layer 420 and the exposed electrode surfaces 444 are planarized. For example, as shown in FIG. 4E, the overburden of the electrode layer 420 may be removed via etching, CMP, and/or the like. Removal of the overburden causes the electrode layer 420 to be segmented into a plurality of segmented electrodes 416 that are separated by the dielectric walls 412.

In various embodiments, the respective exposed electrode surfaces 444 of the plurality of segmented electrodes 416 are planarized. For example, the electrode surfaces 444 may be planarized using CMP, possibly followed by thin film trimming, such that the electrode surface 444 is planar and/or smooth. For example, any topological features of the electrode surface 444 are less than 20 nm. For example, the electrode surface 444 has an RMS roughness of 5 nm or less (e.g., 3 nm or less) when measured over length scales of at least 50 microns. Moreover, in various embodiments, the planarized electrode surfaces are flat and define a plane that is parallel to a plane defined by the surface of the substrate. For example, an angle between the plane defined by the planarized electrode surfaces and the plane defined by the surface of the substate on which the plurality of electrodes is formed is less than 1 degree.

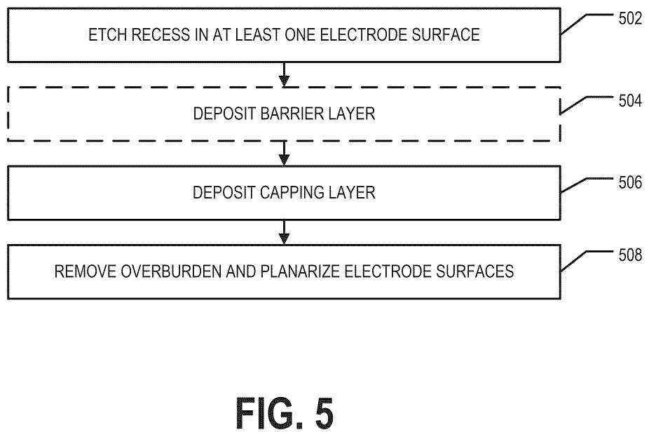

At step 310, in some embodiments including one or more recessed caps are formed in respective segmented electrodes 416. In various embodiments, a recessed cap is a portion of a capping layer that is recessed into a respective electrode surface 444 so as to form a flush, smooth, planar, conductive surface across the respective electrode surface 444. For example, in an example embodiment, a patterned etch, mask etch, lithographic process and/or the like may be used to pattern one or more recesses into respective segmented electrodes 416 (and/or RF electrodes 212), a capping layer may be deposited (possibly on a barrier layer) so as to fill the one or more recesses. The capping layer may then be planarized (e.g., using CMP, a patterned etch, thin film trimming, and/or the like) to provide a smooth, flush, planar, surface on which the metasurface may be formed. In various embodiments, the capping layer is a conductive material. In instances where the resulting metasurface is configured to act, at least in part as a mirror, the capping layer is not transparent to light of a selected frequency range. In instances where the resulting metasurface is configured to act, at least in part, as a lens or diffractive element, the capping layer is transparent to light of a selected frequency range. An example method of forming a recessed cap is described in more detail with respect to FIG. 5 and FIGS. 6A-6E.

At step 312, a metasurface template layer 430 is deposited on the electrode surfaces 444 and patterned to from one or more metasurface templates 432, as shown in FIG. 4F. In various embodiments, the metasurface template layer 430 is deposited using a conformal deposition, such as CVD, ALD, PVD, and/or the like. In various embodiments, a layer of a template material is deposited on the electrode surfaces 444 to form the metasurface template layer 430. In various embodiments, the template material is hard material such as a resist material, an oxide, amorphous silicon (aSi), germanium, a material including germanium, and/or the like and/or a combination thereof. For example, the template material is configured such that a selective etching may be performed to remove the template material while having a minimal effect on the metasurface 442. For example, the template material is a material that may be selectively etched with respect to the metasurface material.

In various embodiments, the metasurface template layer 430 is patterned and etched to form one or more metasurface templates 432 using lithography, greyscale lithography, masked etching, and/or similar processes. In various embodiments, the metasurface templates 432 are each configured to mold the array of pillars and/or columns or holes of a respective metasurface.

In various embodiments, two or more metasurface templates 432 are formed and each of the metasurface templates are configured to mold a distinct array of pillars and/or columns (e.g., an array of pillars and/or columns that is different from each of the other arrays of pillars and/or columns to be molded by the other metasurface templates 432). In various embodiments, two or more metasurface templates 432 are formed and some of the metasurface templates 432 are configured to mold similar arrays of pillars and/or columns (e.g., arrays of pillars and/or columns that are the same but disposed and/or formed on different segmented electrodes 416 and/or RF electrodes 412). In various embodiments, each metasurface template 432 formed in the metasurface template layer 430 is patterned based on a metasurface design for the corresponding metasurface, wherein the metasurface design is determined based on desired optical properties of the metasurface molded thereby.

In various embodiments, the metasurface template layer 430 is deposited on and the metasurface templates 432 are formed therefrom on planarized electrode surfaces 444. For example, the planarized electrode surfaces 444 are sufficiently smooth such that the topology of the electrode surface 444 does not affect the optical properties of the resulting metasurface 442 (which was designed based on a planar base).

At step 314, metasurface material 440 is deposited in the metasurface templates 432 and/or on the metasurface template layer 430, as shown in FIG. 4G. In various embodiments, the metasurface material 440 is a conductive material. In various embodiments, the metasurface material 440 is a transparent conductive oxide (TCO). In an example embodiment, the metasurface material 440 is ITO. In various embodiments, the metasurface material 440 is conformally deposited such that no gaps or vacuum pockets remain in the metasurface templates 432. For example, the metasurface material 440 is deposited using ALD, CVD, and/or the like. The metasurface material 440 deposited within a metasurface template 432 forms a metasurface 442 therein.

In various embodiments, the metasurface material 440 is deposited with an overburden. At step 316, the overburden of the metasurface material 440 is removed. For example, the overburden of the metasurface material 440 may be removed using CMP, dry or wet etching, and/or the like. In an example embodiment, step 316 is performed between steps 314 and 318. In an example embodiment, step 316 is performed between steps 322 and 324. FIG. 4H illustrates an example embodiment where the overburden of metasurface material 440 is removed between steps 314 and 318. In an example embodiment, the overburden of metasurface material 440 is left in place to act as a hard mask to protect the metasurface 442 and/or the smooth/planar electrode surfaces 444 during the selective etching of the dielectric walls 412. In such an embodiment, the overburden would then be removed at step 322.

As illustrated in FIGS. 4G-4M and 6D-6E, in various embodiments, the metasurface 442 comprises a plurality and/or array of pillars and/or columns that extend a feature height out/away from the electrode surface 444. In various embodiments, the feature height is in a range of 0.25 to 15 nm. In some embodiments, the metasurface 442 is a plurality and/or array of holes and/or recesses formed in the electrode surface 444 and/or in a recessed cap 605. For example, the metasurface 442 may comprise a plurality and/or array of holes that extend into the electrode surface a feature depth. For example, in such an example embodiment, steps 314-316 are replaced by performing a patterned etch based on the metasurface template 432 so as to form the plurality and/or array of holes and/or recesses in the electrode surface 444 and/or recessed cap 605. In various embodiments, the feature depth in s in a range of 0.25 to 15 nm.

In various embodiments, the plurality and/or array of pillars comprise pillars of varying feature heights and/or the plurality and/or array of holes comprise holes of varying feature depths. For example at least one pillar/hole of the plurality and/or array of pillars/holes may have a feature height/feature depth that is different from at least one of the other pillars/holes of the plurality and/or array of pillars/holes. In some embodiments, the varying feature heights/depths of the plurality of and/or array of pillars/holes is formed using greyscale lithography. In certain embodiments, the varying feature heights of the plurality and/or array of pillars are formed by, after removing the overburden, repeating the metasurface template patterning process (e.g., similar to step 312) with a new pattern (e.g., a pattern that aligns with some of the pillars but not all the pillars), depositing more metasurface material (e.g., similar to step 314), and removing the overburden (e.g., similar to step 316). The steps of metasurface template patterning, metasurface material deposition, and overburden removal may be repeated multiple times to form the pillars of the desired number of features heights. All of the metasurface templates are removed at step 324.

At step 318, in some embodiments, a hard mask 450 is deposited and patterned. For example, the hard mask 450 is patterned so as to protect the metasurface 442 and the electrodes surfaces 444, as shown in FIG. 41. For example, a layer of mask material is conformally deposited on the metasurface material 440 and/or the metasurface template layer 430. The layer of mask material is then patterned using lithography, greyscale lithography, photoresist, and/or another mask patterning process to provide hard mask 450. The hard mask 450 defines a plurality of openings 454 that align with the dielectric walls 412.

At step 320, the dielectric walls are removed through the openings 454 defined in the hard mask 450 to form gaps 452 disposed between adjacent segmented electrodes 416, as shown in FIG. 4J. For example, a selective and/or wet etch may be performed to remove the dielectric walls 412 from between the segmented electrodes 416. For example, an etching process is performed that is configured to etch away the dielectric material of the dielectric walls 412 and to not etch the electrode material of the segmented electrodes 416 and the hard mask material of the hard mask 450. In various embodiments, the hard mask 450 protects the metasurfaces 442 formed on respective electrode surfaces 444 during the removal of the dielectric walls 412.

In various embodiments, the selective etching is performed to form gaps 452 having a depth d and a width w. In various embodiments, the depth d of the gaps 452 is in a range of 100 nm to 5.5 μm. In various embodiments, the width w of the gaps 452 is such that the depth d to width w ratio is at least 0.5. In various embodiments, the depth d to width w ratio is greater than 0.9, greater than 1.0, greater than 1.1, greater than 1.5, in a range of 1.0 to 3, in a range of 1.0 to 5, in a range of 1.1 to 5, and/or the like.

In an example embodiment, the selective etching of the dielectric walls 412 includes etching undercuts that extend under the segmented electrodes 416.

One or more additional patterning steps may be performed prior to step 322 and/or between steps 322 and 324. For example, while the metasurface 442 is protected by at least the metasurface template layer 430, various other lithographic or other patterning steps may be performed. For example, a load hole for loading atomic objects into the atomic object confinement apparatus 400 may be etched through at least a portion of the substrate 405, in an example embodiment. Various other process, such as performing die singulation, fabricating integrated photonics, performing inline electrical tests of the metasurfaces and/or electrodes, and/or the like, may be performed while the metasurface 442 is protected by at least the metasurface template layer 430 (and possibly the overburden of metasurface material).

At step 322, the hard mask 450 is removed, as shown in FIG. 4K. For example, the hard mask 450 may be removed using a wet or dry etching process, CMP, and/or the like, to expose the template layer 430.

At step 324, the metasurface template layer 430 is removed. For example, a selective and/or wet etching process may be used to remove the metasurface template layer 430. The template material of the metasurface template layer 430 was selected such that the metasurface template layer 430 may be removed without affecting the metasurface 442 and/or with only minimal effect to the metasurface 442.

As shown in FIGS. 4L and 4M, removal of the metasurface template layer 430 leaves behind a metasurface 442 formed of the metasurface material on the planarized electrode surface 444. The metasurface 442 comprises a plurality of pillars or columns formed of the metasurface material and configured to interact with incident light to provide induced beams having desired and/or designed optical properties.

In various embodiments, fabricating the confinement apparatus 400 may include depositing one or more barrier layers, seed layers, adhesion layers and/or the like (e.g., on the surface of the substrate 405 and/or on the electrodes surfaces 444 of the segmented electrodes 416, as appropriate for the materials of the substrate 405, the dielectric material of the dielectric layer 410, the electrode material of the electrode layer 420, and/or the metasurface material of the metasurface 442. For example, in various embodiments, such barrier layers, seed layers, and/or adhesion layers may include TiN, tantalum (Ta), TaN, and/or the like. In various embodiments, such barrier layers, seed layers, and/or adhesion layers may be deposited to a thickness of 0.5 to 50 nm.

FIG. 5 provides a flowchart illustrating various processes, procedures, and/or the like that may be performed to form a recessed cap 605. For example, the processes, procedures, and/or the like illustrated in FIG. 5 may be performed as at least part of step 310, in an example embodiment.

Starting at step 502, a recess 602 is etched in at least one electrode surface 444, as shown in FIG. 6A. For example, a patterned etch, masked etch, lithographic process, and/or the like may be used to etch recesses 602 into respective electrode surfaces 444. In various embodiments, the recess 602 extends into the segmented electrode 416 (or RF electrode 212) 50 to 200 nm).

At step 504 of FIG. 5, an optional barrier layer 610 is deposited along the electrode surfaces 444 and in the recesses 602. In various embodiments, the barrier layer 610 is deposited conformally using ALD, CVD, PVD (e.g., sputtering) or another appropriate deposition process. In an example embodiment, the barrier layer 610 is deposited to a depth of 10-50 nm. In an example embodiment, the barrier layer comprises TiN. In various embodiments, the barrier layer 610 is configured to mechanically and/or chemically isolate the capping component 622 of the recessed cap 605 from the bulk metal material of the host electrode (e.g., segmented electrode 416 and/or RF electrode 212).

At step 506, a capping layer 620 is deposited onto the barrier layer 610 (if such is present) or along the electrode surfaces 444 and in the recesses 602. In various embodiments, the capping layer 620 is deposited conformally using ALD, CVD, PVD, and/or another appropriate deposition process. In various embodiments, the capping layer 620 is deposited to a depth of 10 to 100 nm.

In various embodiments where the resulting metasurface 442 is configured to act at least in part like a mirror, the capping layer 620 comprises a reflective and/or metal material such as Al, Cu, W, and/or the like. For example, the capping layer 620 may be selected to not be transparent and/or to be reflective for light of a selected frequency range. For example, if the selected frequency range is a visible frequency range, the capping layer 620 may comprise Al. In another example, when the selected frequency range is a near IR to near-visible frequency range, the capping layer 620 may comprise Cu.

In various embodiments where the resulting metasurface 442 is configured to act at least in part like a lens or diffractive element, the capping layer 620 may comprise a conductive material that is transparent to light of the selected wavelength range. For example, the capping layer 620 may comprise Nb, ITO, AZO, In₂O₃, TiN, TaN, Au, Pt, and/or the like, in various embodiments.

FIG. 6B illustrates a point in the fabrication of the atomic object confinement apparatus 600 where the recess 602 has been filled by the deposition of the barrier layer 610 and the capping layer 620.

Continuing with FIG. 5, at step 508, any overburden of the barrier layer 610 and/or capping layer 620 is removed and the electrode surface 444 (now including the recessed cap 605) is planarized. For example, CMP and/or patterned etching may be performed to remove any overburden of the barrier layer 610 and/or capping layer 620 and to ensure the electrode surface 444 (now including the recessed cap 605) is smooth and/or planarized. In some embodiments, a thin film trimming process may be removed to address any residual thickness variation after performance of CMP and/or patterned etching.

For example, the electrode surface 444 may be smoothed and/or planarized such that the electrode surface 444 has an RMS roughness of 5 nm or less (e.g., 3 nm or less) when measured over length scales of at least 50 microns. For example, the topology of the surface electrodes is made to be sufficiently smooth such that the topology of the surface electrodes (including the topology of the recessed cap) does not affect the optical properties of the metasurfaces. Moreover, in various embodiments, the planarized electrode surfaces 444 are caused to be flat and to define a plane that is parallel to a plane defined by the surface of the substrate. For example, an angle between the plane defined by the planarized electrode surfaces and the plane defined by the surface of the substate on which the plurality of electrodes is formed is less than 1 degree.

Removal of the overburden of the barrier layer 610 and/or the capping layer 620 forms the recessed cap 605. In the illustrated embodiment, the recessed cap 605 includes a cap barrier 612 and a capping component 622. In some embodiments, a barrier layer 610 is not deposited and the recessed cap 605 only includes the capping component 622. In various embodiments wherein the capping component 622 is conductive and transparent to light in the selected frequency range, the capping component may have a thickness of 10-50 nm. In various embodiments wherein the capping component 622 is conductive and not transparent (e.g., is reflective) to light in the selected frequency range, the capping component 622 may have a thickness in a range of 50 to 100 nm.

After performing step 508, the process may continue to step 312. FIG. 6D illustrates an example atomic object confinement apparatus 600 that is similar to the atomic object confinement apparatus 400 but includes a recessed cap 605. For example, the illustrated metasurface of the atomic object confinement apparatus 400, 600 is configured to act, at least in part, like a mirror. FIG. 6E illustrates an example atomic object confinement apparatus 600′ that is similar to the atomic object confinement apparatus 400′ but includes a recessed cap 605. For example, the example atomic object confinement apparatus 400′, 600′ include one or more photonic layers 460 and the illustrated metasurfaces 442 thereof are configured to act, at least in part, as lenses and/or diffractive elements.

In various embodiments, various patterned components may be formed using a template 432 on the planarized surface of an electrode and/or on a recessed cap 605 that is formed in the electrode. Some examples of patterned components that may be using a template 432 on the planarized surface of an electrode and/or on a recessed cap 605 that is formed in the electrode include metasurfaces, diffractive optical elements (e.g., lenses, etc.), and photonic alignment marks (e.g., for aligning externally provided beams with respective target locations of the confinement apparatus).

### Technical Advantages

For confinement apparatuses having integrated photonic elements (such as metasurfaces), positioning the optical components with respect to the electrical components (e.g., surface electrodes, etc.) can be difficult. For example, a significant amount of the surface of the confinement apparatus may be filled with the segmented electrodes used to generate the trapping potential configured to confine the atomic objects. Additionally, any electrical charge that becomes trapped on the optical components formed on the surface of the confinement apparatus (e.g., on metasurfaces formed on the surface of the confinement apparatus) could negatively affect operation of the confinement apparatus. Therefore, technical problems exist regarding the incorporation of integrated photonic elements (such as metasurfaces) in confinement apparatuses.

Moreover, conventional methods for forming surface electrodes of a confinement apparatus, such as metal lift off and direct metal etching tend to result in surface electrodes with significant surface topology. For example, the exposed electrode surface of the segmented surface electrodes formed through conventional surface electrode fabrication processes are not planar and/or smooth on a nanometer size scale. For example, conventional surface electrode fabrication processes include micron scale topological features. Fabrication of nano-scale features of a metasurface on a surface having micron scale topological features is technically quite difficult. Moreover, in some instances, the topology of the exposed surface of the surface electrodes is significant enough to affect the optical properties of a metasurface and/or other optical component formed on the electrode surface of the segmented surface electrodes. Therefore, additional technical problems exist regarding how to form metasurfaces on electrode surfaces of segmented surface electrodes such that the metasurfaces have predictively reliable optical properties.

Embodiments of the present disclosure provide technical solutions to these technical problems. Various embodiments provide confinement apparatuses, systems comprising confinement apparatuses, and/or methods for fabricating confinement apparatuses that include metasurfaces formed on (and/or in) the electrode surfaces of respective segmented electrodes of the confinement apparatus. In various embodiments, the segmented electrodes are formed using a damascene mask process. For example, dielectric walls are formed on a substrate. An electrode material layer is deposited on the substrate and the dielectric walls and then planarized. The planarization may be performed by chemical mechanical polishing (CMP), a patterned etch, and/or thin film trimming. For example, in certain embodiments, CMP may be performed and then a thin film trimming process may be performed to address residual thickness variation.

The planarized electrode surfaces have a root mean square (RMS) roughness of 5 nm or less (e.g., 3 nm or less) when measured over length scales of at least 50 microns. For example, the planarized electrode surface are free of topological features greater than 10-20 nm, in various embodiments. Thus, the topology of the surface electrodes is sufficiently smooth that the topology of the surface electrodes does not affect the optical properties of the metasurfaces. Moreover, in various embodiments, the planarized electrode surfaces are flat and define a plane that is parallel to a plane defined by the surface of the substrate. For example, an angle between the plane defined by the planarized electrode surfaces and the plane defined by the surface of the substate on which the plurality of electrodes is formed is less than 1 degree.

A template layer is deposited on the planarized electrode surfaces. The template layer is then patterned using lithographic processes, greyscale lithographic processes, masked etching, and/or the like to form metasurface templates therein. A metasurface material layer may then be conformally deposited on the template layer to form respective metasurfaces in the respective metasurface templates. The dielectric walls are then removed using a selective etch to form gaps between the segmented surface electrodes such that the electrodes are electrically isolated from one another by the gaps. The metasurfaces may be protected by hard mask while the selective etching is performed to form the gaps. By enabling the metasurfaces to be located on the segmented electrodes on the surface of the confinement apparatus, a variety of options for the positioning of the metasurfaces is provided.

Furthermore, in various embodiments, the metasurfaces are formed of a metasurface material. In an example embodiment, the metasurface material is electrically conductive. For example, the metasurface material is a transparent conducting oxide (TCO), such as indium tin oxide (ITO), in various embodiments. Thus, the metasurfaces are grounded by being formed on the segmented electrodes and will not trap excess charges on the surface of the confinement apparatus.

Additionally, by enabling the metasurfaces to be disposed on the surfaces of the electrodes, various embodiments provide a significant increase in flexibility regarding placement of the metasurfaces and in how manipulation signals (e.g., laser beams and/or pulses) are provided to atomic object locations (which are defined at least in part by the atomic object confinement apparatus) and the atomic objects located thereat. By enabling manipulation signals to be provided to atomic object locations using out-of-plane beam paths (e.g., beam paths that are not parallel to a plane defined by the surface of the atomic object confinement apparatus), various embodiments enable the confinement apparatus to be increased in size to be able to confine more atomic objects (e.g., resulting in more qubits available to a quantum computer including the confinement apparatus, for example) and/or to define more atomic object locations at which controlled quantum state evolution of the atomic objects may be performed.

Moreover, the flexibility in placement of metasurfaces and the use of metasurfaces to direct out-of-plane propagating manipulation signals toward atomic object locations reduces the precision with which external beam delivery systems need to be aligned with their target locations. This enables for improved qubit performance (e.g., improved gate fidelity) since small misalignments of the external beam delivery system will not result in large differences in the (e.g., the amplitude of) the manipulation signal provided to an atomic object location.

Various embodiments therefore provide improvements to the technical fields of confinement apparatuses, confinement apparatuses including integrated photonic elements, systems including confinement apparatuses (including confinement apparatus having integrated photonic elements), methods for fabricating confinement apparatuses (including confinement apparatus having integrated photonic elements), and quantum computing (e.g., quantum charge-coupled device (QCCD)-based quantum computing).

### Exemplary Controller

Various embodiments provide systems comprising confinement apparatuses 400, 400′. For example, various atomic systems, quantum systems, and/or the like may use a confinement apparatus 400, 400′ to confine one or more atomic objects. In an example embodiment, the system is a quantum charge-coupled device (QCCD-based) quantum computer 110 or another quantum computer. In various embodiments, the system (e.g., quantum computer 110) includes a controller 30 configured to control various elements of the system. For example, the controller 30 may be configured to control the voltage sources 50, a cryogenic system and/or vacuum system for controlling the temperature and pressure within the cryogenic and/or vacuum chamber 40, manipulation sources 64 (e.g., 64A, 64B, 64C), magnetic field sources 70 (e.g., 70A, 70B), and/or other systems controlling the environmental conditions (e.g., temperature, humidity, pressure, magnetic field gradient, and/or the like) within the cryogenic and/or vacuum chamber 40, configured to manipulate and/or cause a controlled evolution of quantum states of one or more atomic objects confined by the confinement apparatus, and/or read and/or detect a quantum state of one or more atomic objects confined by the confinement apparatus.

As shown in FIG. 7, in various embodiments, the controller 30 may comprise various controller elements including one or more processing devices 705, memory 710, driver controller elements 715, a communication interface 720, analog-digital converter elements 725, and/or the like. For example, the one or more processing devices 705 may comprise one or more processing elements such as programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like. The term circuitry may refer to an entirely hardware embodiment or a combination of hardware and computer program products. In an example embodiment, the one or more processing devices 705 of the controller 30 comprises a clock and/or is in communication with a clock. In various embodiments, this clock defines the clock cycles of the system.

For example, the memory 710 may comprise non-transitory memory such as volatile and/or non-volatile memory storage such as one or more of as hard disks, ROM, PROM, EPROM, EEPROM, flash memory, MMCs, SD memory cards, Memory Sticks, CBRAM, PRAM, FeRAM, RRAM, SONOS, racetrack memory, RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. In various embodiments, the memory 710 may store qubit records corresponding the qubits of quantum computer (e.g., in a qubit record data store, qubit record database, qubit record table, and/or the like), a calibration table, an executable queue, computer program code (e.g., in a one or more computer languages, specialized controller language(s), and/or the like), and/or the like. In an example embodiment, execution of at least a portion of the computer program code stored in the memory 710 (e.g., by a processing device 705) causes the controller 30 to perform one or more steps, operations, processes, procedures and/or the like described herein for controlling one or more components of the quantum computer 110 (e.g., voltages sources 50, manipulation sources 64, magnetic field sources 70, and/or the like) to cause a controlled evolution of quantum states of one or more atomic objects, detect and/or read the quantum state of one or more atomic objects, and/or the like.

In various embodiments, the driver controller elements 715 may include one or more drivers and/or controller elements each configured to control one or more drivers. In various embodiments, the driver controller elements 715 may comprise drivers and/or driver controllers. For example, the driver controllers may be configured to cause one or more corresponding drivers to be operated in accordance with executable instructions, commands, and/or the like scheduled and executed by the controller 30 (e.g., by the processing device 705). In various embodiments, the driver controller elements 715 may enable the controller 30 to operate a manipulation source 64. In various embodiments, the drivers may be laser drivers; vacuum component drivers; drivers for controlling the flow of current and/or voltage applied to the segmented electrodes (e.g., the RF, control, and/or other electrodes of the confinement apparatus 400, 400′, 600, 600′) used for maintaining and/or controlling the confinement potential of the confinement apparatus (and/or other driver for providing driver action sequences and/or control signals to potential generating elements of the confinement apparatus); cryogenic and/or vacuum system component drivers; and/or the like. For example, the drivers may control and/or comprise control and/or RF voltage drivers and/or voltage sources that provide voltages and/or electrical signals to the segmented electrodes 416 (e.g., control electrodes 216 and/or RF electrodes 212). In various embodiments, the controller 30 comprises means for communicating and/or receiving signals from one or more detectors such as optical receiver components (e.g., cameras, MEMs cameras, CCD cameras, photodiodes, photomultiplier tubes, and/or the like) of the optics collection system 80. For example, the controller 30 may comprise one or more analog-digital converter elements 725 configured to receive signals from one or more detectors, optical receiver components, calibration sensors, and/or the like.

In various embodiments, the controller 30 may comprise a communication interface 720 for interfacing and/or communicating with one or more computing entities 10. For example, the controller 30 may comprise a communication interface 720 for receiving executable instructions, command sets, and/or the like from the computing entity 10 and providing output received from the quantum processor 115 (e.g., via the optics collection system 80) and/or the result of a processing the output (received from the quantum processor 115) to the computing entity 10. In various embodiments, the computing entity 10 and the controller 30 may communicate via a direct wired and/or wireless connection and/or one or more wired and/or wireless networks 20.

### Exemplary Computing Entity

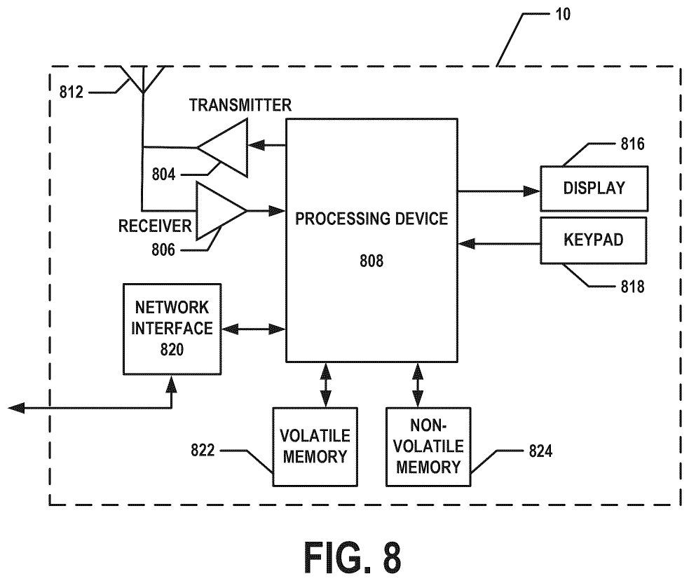

FIG. 8 provides an illustrative schematic representative of an example computing entity 10 that can be used in conjunction with embodiments of the present invention. In various embodiments, a computing entity 10 is configured to allow a user to provide input to the quantum computer 110 (e.g., via a user interface of the computing entity 10) and receive, display, analyze, and/or the like output from the quantum computer 110.

As shown in FIG. 8, a computing entity 10 can include an antenna 812, a transmitter 804 (e.g., radio), a receiver 806 (e.g., radio), and a processing device 808 that provides signals to and receives signals from the transmitter 804 and receiver 806, respectively.

The signals provided to and received from the transmitter 804 and the receiver 806, respectively, may include signaling information/data in accordance with an air interface standard of applicable wireless systems to communicate with various entities, such as a controller 30, other computing entities 10, and/or the like. In this regard, the computing entity 10 may be capable of operating with one or more air interface standards, communication protocols, modulation types, and access types. For example, the computing entity 10 may be configured to receive and/or provide communications using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 10 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The computing entity 10 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

Via these communication standards and protocols, the computing entity 10 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The computing entity 10 can also download changes, add-ons, and updates, for instance, to its firmware, software (e.g., including executable instructions, applications, program modules), and operating system. In various embodiments, the computing entity 10 further comprises one or more network interfaces 820 configured to communicate via one or more wired and/or wireless networks 20.

The computing entity 10 may also comprise a user interface device comprising one or more user input/output interfaces (e.g., a display 816 and/or speaker/speaker driver coupled to a processing device 808 and a touch screen, keyboard, mouse, and/or microphone coupled to a processing device 808). For instance, the user output interface may be configured to provide an application, browser, user interface, interface, dashboard, screen, webpage, page, and/or similar words used herein interchangeably executing on and/or accessible via the computing entity 10 to cause display or audible presentation of information/data and for interaction therewith via one or more user input interfaces. The user input interface can comprise any of a number of devices allowing the computing entity 10 to receive data, such as a keypad 818 (hard or soft), a touch display, voice/speech or motion interfaces, scanners, readers, or other input device. In embodiments including a keypad 818, the keypad 818 can include (or cause display of) the conventional numeric (0-9) and related keys (#, *), and other keys used for operating the computing entity 10 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the computing entity 10 can collect information/data, user interaction/input, and/or the like.

The computing entity 10 can also include volatile storage or memory 822 and/or non-volatile storage or memory 824, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the computing entity 10.

### Conclusion

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. An atomic object confinement apparatus comprising:
a substrate comprising a plurality of metal routing features;
a plurality of electrodes disposed on a surface of the substrate and in electric communication with respective metal routing features of the plurality of metal routing features; and
a patterned component formed on an electrode surface of an electrode of the plurality of electrodes.

2. (canceled)

3. The atomic object confinement apparatus of claim 1, wherein the electrode surface has a root mean squared (RMS) roughness of 5 nm or less when measured over length scales of at least 50 microns.

4. (canceled)

5. (canceled)

6. The atomic object confinement apparatus of claim 1, further comprising a plurality of gaps, respective gaps of the plurality of gaps disposed between adjacent electrodes of the plurality of segmented electrodes, wherein each gap of the plurality of gaps has a depth to width ratio of at least 0.5.

7. (canceled)

8. The atomic object confinement apparatus of claim 1, further comprising at least one window post embedded within the electrode, wherein the at least one window post comprises a dielectric material that is transparent for light of at least a selected range of frequencies of light.

9. The atomic object confinement apparatus of claim 8, wherein the at least one window post is optically aligned with the patterned component.

10. The atomic object confinement apparatus of claim 9, wherein the electrode surface comprises a recessed cap comprising a material that is conductive and transparent for light of at least the selected range of frequencies of light.

11. The atomic object confinement apparatus of claim 1, wherein respective exposed surfaces of the plurality of electrodes define a plane that forms an angle with a plane defined by a surface of the substrate and the angle measures one degree or less.

12. The atomic object confinement apparatus of claim 1, wherein the patterned component is formed of an electrically conductive material.

13. The atomic object confinement apparatus of claim 1, wherein the patterned component is a metasurface and the metasurface comprises at least one of (a) a plurality of pillars or (b) a plurality or array of holes.

14. The atomic object confinement apparatus of claim 13, wherein either the plurality of pillars have varying heights or the plurality or array of holes have varying depths.

15. The atomic object confinement apparatus of claim 1, wherein the patterned component is a metasurface, a diffractive optical element, or an alignment mark.

16. A method for fabricating an atomic object confinement apparatus, the method comprising:
forming, on a surface of a substrate, a plurality of electrodes separated by dielectric walls, the plurality of electrodes having planarized electrode surfaces;
depositing a template layer on the electrode surfaces and the dielectric walls;
patterning the template layer to define a template within the template layer;
forming a patterned component on a planarized electrode surface of an electrode of the plurality of electrodes based on the template;
depositing and patterning a hard mask, the hard mask configured to protect the patterned component and the planarized electrode surfaces;
selectively etching away the dielectric walls to form a plurality of gaps, wherein respective gaps of the plurality of gaps are disposed between adjacent electrodes of the plurality of segmented electrodes; and
removing the hard mask.

17. The method of claim 16, wherein the patterned component is a metasurface and forming the metasurface on the planarized electrode surface based on the metasurface template comprises one of:
depositing a metasurface material layer on the metasurface template to form a plurality of pillars that collectively define the metasurface, or
etching a plurality of holes into the planarized electrode surface using the metasurface template as a mask, the plurality of holes collectively defining the metasurface.

18. The method of claim 17, wherein the metasurface material layer is deposited with an overburden and the method further comprises one of:
after removal of the hard mask, removing the overburden, or
prior to depositing and forming the hard mask, removing the overburden, or
using the overburden as the hard mask.

19. (canceled)

20. The method of claim 16, further comprising removing the template layer.

21. The method of claim 16, wherein forming the template within the template layer includes using a lithographic process to form the template within the template layer.

22. The method of claim 21, wherein the lithographic process is a greyscale lithographic process.

23. (canceled)

24. (canceled)

25. The method of claim 16, wherein a window post is embedded within the electrode, the window post comprises a material that is transparent for light of at least a selected range of frequencies of light, and the window post is optically aligned with the patterned component.

26. The method of claim 25 further comprising forming a recessed cap that is at least partially aligned with the window post, the recessed cap comprising a capping component that is electrically conductive and transparent for light of at least a selected range of frequencies of light.

27. (canceled)

28. The method of claim 16, further comprising forming a recessed cap in the electrode surface prior to forming the patterned component thereon, the patterned component being disposed on the recessed cap.

29. (canceled)
